(19) United States
(12) Patent Application Publication
(10) Pub. No.: US 2008/0068183 A1
(43) Pub. Date: Mar. 20, 2008

(54) Methods and apparatus for accessing, or providing access to, user-configurable or different response policies for different duress codes

(76) Inventor: John R. Diamant, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/521,896

(22) Filed: Sep. 15, 2006

(51) Int. Cl. G08B 13/00

(52) U.S. Cl. 340/574; 340/534; 340/539.18

(57) ABSTRACT

In accord with a first computer-implemented method, 1) a plurality of duress codes are assigned to a number of users; 2) different response policies are configured for different ones of the duress codes; and 3) access to the response policies is provided via an interface of a policy engine. The response policies are retrieved, via the interface, as users enter ones of the duress codes into ones of a number of computer systems. Other embodiments are also disclosed.

### BACKGROUND

Various types of security systems may be utilized to protect computer-based resources such as applications, files and databases. The security systems may be used to protect the computer-based resources from thieves, hackers and other unauthorized users.

As security systems improve, gaining access to computer-based resources by means of compromising their security system(s) is becoming more and more difficult. However, security systems must still permit access by authorized users. Unauthorized users can therefore defeat a security system by forcing or coercing an authorized user to disclose their login information and/or hand over necessary security items (which may include, for example, a username, password, PIN, question answer, smart card, key fob or other code or item). The unauthorized user may then bypass a computer's security system(s) by simply logging on as if they were an authorized user.

Although an authorized user could refuse to give an unauthorized user their login information, there are times when this could jeopardize the authorized user's safety. In this regard, a user may sometimes be provided a duress code (which, for example, may take the form of a different username or password). When entered into a computer system, the duress code may trigger an alarm or slow access to the computer system. In this manner, an authorized user may 1) provide an unauthorized user his or her duress code, 2) be likely to avoid physical harm, and 3) indirectly alert someone that an unauthorized user is attempting to gain access to a computer system that they are not authorized to access.

### BRIEF DESCRIPTION OF THE DRAWINGS

Illustrative embodiments of the invention are illustrated in the drawings, in which:

FIG. 1 illustrates an exemplary computer-implemented method in which different response policies may be configured for different duress codes;

FIG. 2 illustrates exemplary computer-readable program code that can be used to facilitate the implementation of the method shown in FIG. 1;

FIG. 3 illustrates an exemplary embodiment of hardware and software structures that can be used to implement the method shown in FIG. 1; and

FIG. 4 illustrates an exemplary computer-implemented method for indexing a store of duress codes and response policies, such as those that might be served by the policy engine shown in FIG. 3.

### DETAILED DESCRIPTION

In the past, duress codes have been used to trigger an alarm, slow access to a computer system, or trigger other simple, hard-coded actions. Also, in an enterprise having many authorized users, each user's duress code (if they have one) triggers the same action (e.g., the issuance of an alarm).

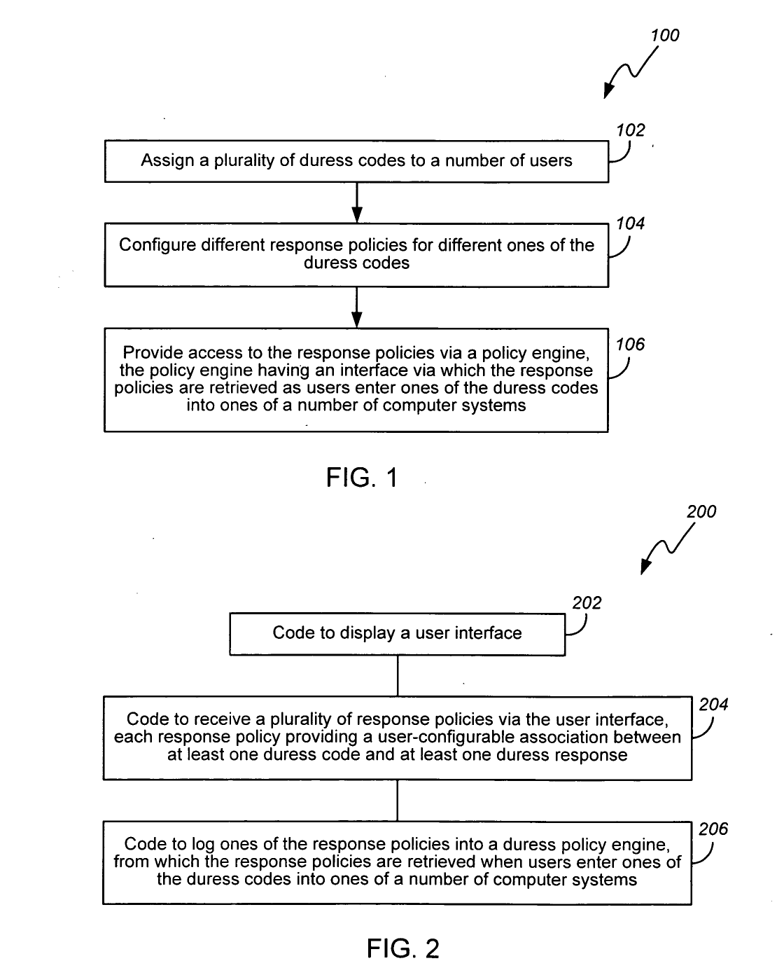

FIG. 1 illustrates a new and exemplary computer-implemented method 100, in which different response policies may be configured for different duress codes. In accord with the method 100, a plurality of duress codes are assigned to a number of users (block 102). In some cases, this may involve assigning different duress codes to different users. Alternately (or additionally), a plurality of different duress codes may be assigned to just a single user, or to some or all of the users in a group.

The method 100 continues with the configuration of different response policies for different ones of the duress codes (block 104). Depending on which user is assigned which duress code(s), this may result in different duress responses being associated with different users' duress codes, or different duress responses being associated with different duress codes known by a single user.

After duress codes have been assigned to users, and response policies have been associated with the duress codes, access to the response policies is provided via an interface of a policy engine. The response policies may then be retrieved from the policy engine as users enter ones of the duress codes into ones of a number of computer systems (block 106).

Of note, the steps of the method 100 are not critical. For example, the different response policies could be configured first, with the duress codes being assigned to one or more of the users based on the manner in which their corresponding response policies have been configured. Also, and in an ongoing enterprise, various of the method's steps could be repeated in various orders (or at the same time).

By enabling the configuration of different response policies for different duress codes, the method 100 enables a system administrator or other party to tailor duress responses to different situations. For example, there may some situations that do not warrant alarm, or there may be different situations that warrant different types of alarm (e.g., a silent alarm versus an audible alarm). Also, consider a situation where many of a company's employees have limited access rights, but others have substantial access rights. Using the method 100, a system administrator could provide the employees with limited access rights a duress code that simply 1) triggers a silent alarm, or 2) causes an unauthorized user's actions to be logged. On the other hand, an employee with substantial rights might be provided with a duress code that 1) causes an unauthorized user to be given access to honeypot applications, or 2) triggers procedures that cause the unauthorized user to believe that some or all of his actions are being carried out, when in fact, some or all of his actions are being prevented from being carried out.

In one embodiment of the method 100, the interface of the policy engine is accessed via an access authentication system that authorizes user-access to ones of the number of computer systems. By way of example, the authentication system could be a Lightweight Directory Access Protocol (LDAP) authentication system, a Windows® Directory Service authentication system, or a Hewlett-Packard (HP) Select Access authentication system.

The different response policies provided by the method 100 may be variously configured. For example, a response policy could trigger procedures for activating alarm; procedures for slowing down access to a device (e.g., a computer system or database); or procedures for mimicking a normal-mode of a device. A response policy may also be more involved, and may include multiple actions. For example, a response policy could trigger procedures for 1) representing to a user that at least some of their actions have been carried out, but 2) preventing the actions from being carried out. Or, a response policy could trigger procedures for logging and undoing at least some of the actions that are taken by a user. Response policies could also take other forms, including combinations of the above response policies.

In some cases, a response policy may be configured to take one or more actions in response to 1) the entry of a given duress code, and 2) the existence of one or more conditions. In this manner, a single duress code could trigger the invocation of different response policies. Conditions that could be assessed include: the time of entry of a given duress code, the site at which a given duress code is entered (e.g., the identity of a particular computer system, or the current location of a portable computer system); the type of action that is requested following the entry of a given duress code; or the receipt of a particular input (e.g., biometrics or a credit card) via an auxiliary input device. Alternately (or additionally), a user's actions could be monitored following his entry of a duress code into a computer system. A duress response policy could then be configured to take different actions in response to different user actions.

The method 100 may be implemented within or between one or more computer systems, by executing computer-readable program code stored on computer-readable media. The computer-readable media may include, for example, any number or mixture of fixed or removable media (such as one or more fixed disks, random access memories (RAMs), read-only memories (ROMs), or compact discs), at either a single location or distributed over a network. The computer-readable program code may include, for example, instructions embodied in software or firmware.

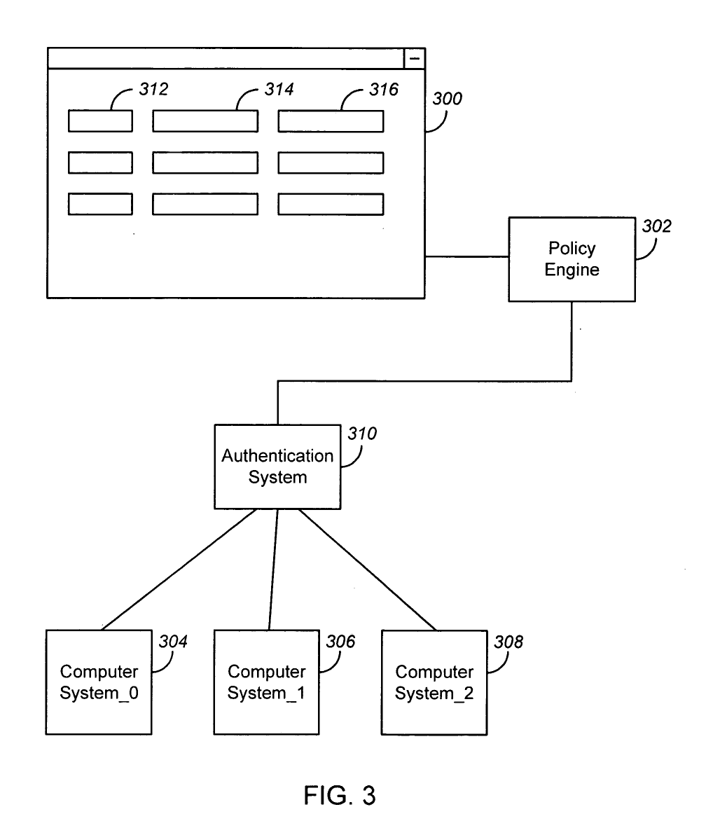

The computer-readable program code used to implement the method 100 (FIG. 1) may include various components, but in one embodiment, includes the program code 200 shown in FIG. 2. The code 200 includes code 202 to display a user interface 300 (FIG. 3), and code 204 to receive a plurality of response policies via the user interface 300. Each of the response policies provides a user-configurable association between at least one duress code and at least one duress response. Code 206 is provided to log ones of the response policies into a duress policy engine 302, from which the response policies are retrieved when users enter ones of the duress codes into ones of a number of computer systems 304, 306, 308. In one embodiment, the computer systems 304, 306, 308 access the policy engine 302 by way of an authentication system 310.

An exemplary embodiment of the user interface 300 is shown in FIG. 3. As shown, the user interface 300 may take the form of a graphical user interface (GUI) having one or more input areas 312, 314, 316. In one embodiment, some of the input areas may be configured to receive response polices that take different actions in response to different user actions. Or, the input areas may be configured to receive response policies that take one or more actions in response to 1) entry of a given one of the duress codes, and 2) the existence of at least one condition. The input areas may also be configured in other ways, so as to receive any of the user-configurable response policies discussed herein (as well as other response policies).

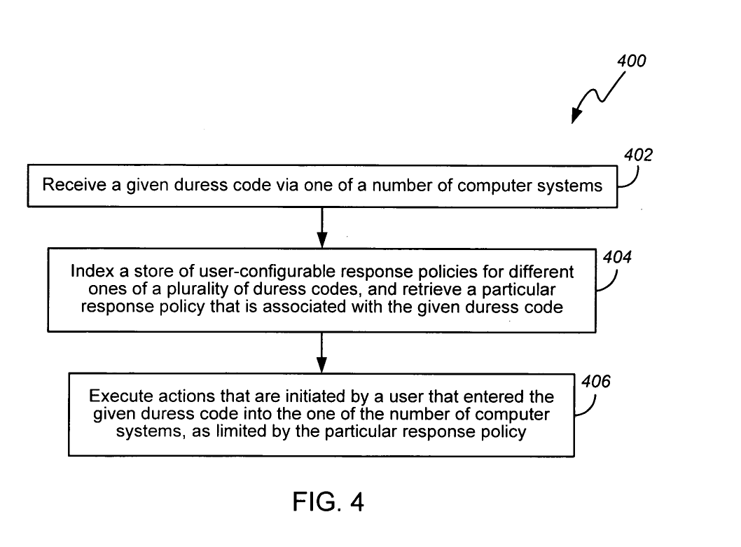

FIG. 4 illustrates an exemplary computer-implemented method 400 for indexing a store of duress codes and response policies, such as those that might be served by the policy engine that has been described herein. The method 400 comprises 1) receiving a given duress code via one of a number of computer systems (block 402); 2) indexing a store of user-configurable response policies for different ones of a plurality of duress codes, and retrieving a particular response policy that is associated with the given duress code (block 404); and 3) executing actions that are initiated by a user that entered the given duress code into one of the computer systems (block 406). Of note, the actions that are executed are limited by the particular response policy.

As with the method 100, the method 400 may be implemented within or between one or more computer systems, by executing computer-readable program code stored on computer-readable media.

In addition to providing a system administrator or similar party with greater flexibility in responding to a duress code, the methods and apparatus described herein can mitigate or eliminate the need to modify a particular application to respond to a duress situation. For example, a duress response policy may be configured to capitalize on different capabilities that are already provided by an application (e.g., the ability to open different databases). The use of a policy engine, in lieu of tying a duress response to a particular application, also enables a duress response to be reconfigured when conditions warrant.

What is claimed is:

1. A computer-implemented method, comprising:
assigning a plurality of duress codes to a number of users;
configuring different response policies for different ones of the duress codes; and
providing access to the response policies via a policy engine, the policy engine having an interface via which the response policies are retrieved as users enter ones of the duress codes into ones of a number of computer systems.

2. The method of claim 1, wherein:
a plurality of the duress codes are assigned to a given one of the users; and
different response policies are configured for at least two different ones of the duress codes assigned to the given user.

3. The method of claim 1, wherein:
the plurality of duress codes are assigned to a plurality of users; and
different response policies are configured for i) one of the duress codes assigned to a first of the users, and ii) one of the duress codes assigned to a second of the users.

4. The method of claim 1, further comprising, accessing the interface of the policy engine via an access authentication system that authorizes user-access to ones of the number of computer systems.

5. The method of claim 1, further comprising, configuring one of the response policies to take at least a first action in response to i) entry of a given one of the duress codes, and ii) existence of one or more conditions.

6. The method of claim 1, further comprising:
when a user enters one of the duress codes into one of the computer systems, monitoring the user's actions; and
configuring one of the response policies to take different actions in response to different user actions.

7. The method of claim 1, further comprising:
configuring a first of the response policies to take at least a first action in response to i) entry of a given one of the duress codes, and ii) existence of at least a first condition; and
configuring a second of the response policies to take at least a second action, different from the first action, in response to i) entry of the given one of the duress codes, and ii) existence of at least a second condition.

8. The method of claim 7, wherein at least one of the response policies triggers procedures for i) representing to a user that at least some actions have been carried out, but ii) preventing the at least some actions from being carried out.

9. The method of claim 7, wherein at least one of the response policies triggers procedures for logging and undoing at least some actions that are taken by a user after entry of one of the duress codes.

10. The method of claim 7, wherein the first condition is entry of the given duress code at a particular time.

11. The method of claim 7, wherein the first condition is entry of the given duress code at a particular site.

12. The method of claim 7, wherein the first condition is a type of action requested following entry of the given duress code.

13. The method of claim 7, wherein the first condition is receipt of a particular input via an auxiliary input device.

14. The method of claim 7, wherein at least one of the response policies triggers procedures for slowing down access to a device.

15. The method of claim 7, wherein at least one of the response policies triggers procedures for mimicking a normal-mode of a device.

16. The method of claim 7, wherein at least one of the response policies triggers procedures for activating an alarm.

17. Apparatus, comprising:
computer-readable media; and
computer-readable program code, stored on the computer-readable media, including,
code to display a user interface;
code to receive a plurality of response policies via the user interface, each response policy providing a user-configurable association between at least one duress code and at least one duress response; and
code to log ones of the response policies into a duress policy engine, from which the response policies are retrieved when users enter ones of the duress codes into ones of a number of computer systems.

18. The apparatus of claim 17, wherein the user interface provides one or more input areas to receive response polices that take different actions in response to different user actions.

19. The apparatus of claim 17, wherein the user interface provides one or more input areas to receive response policies that take at least a first action in response to i) entry of a given one of the duress codes, and ii) existence of at least one condition.

20. A computer-implemented method, comprising:
receiving a given duress code via one of a number of computer systems;
indexing. a store of user-configurable response policies for different ones of a plurality of duress codes, and retrieving a particular response policy that is associated with the given duress code; and
executing actions that are initiated by a user that entered the given duress code into the one of the number of computer systems, as limited by the particular response policy.

21. Apparatus, comprising:
computer-readable media; and
computer-readable program code, stored on the computer-readable media, including,
code to receive duress codes via a number of computer systems;
code to, upon receipt of a given one of the duress codes, i) index a store of user-configurable response policies for different ones of a plurality of duress codes, and ii) retrieve a particular response policy that is associated with the given duress code; and
code to execute actions that are initiated by a user that entered the given duress code into the one of the number of computer systems, as limited by the particular response policy.
